(19) United States
(12) Patent Application Publication
(10) Pub. No.: US 2006/0245196 A1
(43) Pub. Date: Nov. 2, 2006

(54) Decorative light fixture extension system for use with outdoor lighting fixtures

(76) Inventor: Troy L. Haynes, Aptos, CA (US)

Correspondence Address: R. MICHAEL WEST LAW OFFICES OF;R. MICHAEL WEST, A PROFESSIONAL CORPORATION, 455 CAPITOL MALL; SUITE 405, SACRAMENTO, CA, 95814-4603, US

(21) Appl. No.: 11/120,907

(22) Filed: May 2, 2005

(51) Int. Cl. F21V 11/00

(52) U.S. Cl. 362/351

(57) ABSTRACT

A decorative light fixture extension system detachably mounted over the upper end of an existing outdoor lighting fixture. The top cap or cover of the existing lighting fixture is removed. A vertically oriented socket extension is plugged into the existing bulb socket. A decorative light housing is lowered over the bulb and the upper end of the socket extension, and detachably secured over the upper end of the existing light fixture. The decorative light housing is provided with a transparent or translucent portion which is adapted through its configuration and color, to present visual image relating, for example, to a particular season of the year, a holiday, a political theme, or a sports team allegiance. The means of attachment between the decorative light housing and the existing light fixture is such that different decorative housings may readily be substituted and utilized.

### BACKGROUND OF THE INVENTION

1. Field of the Invention

The invention relates generally to improvements in the field of outdoor lighting systems comprised of a plurality of ground or deck-mounted lighting fixtures used for illuminating driveways, walkways, landscaping features, and decks. More particularly, the invention pertains to a decorative light fixture extension system which is detachably mounted over the upper end of each existing outdoor lighting fixture, to provide an illuminated visual image communicating a theme or message of the user's choice.

2. Description of the Prior Art

The prior art includes outdoor lighting systems employing a plurality of ground or deck-mounted light fixtures, electrically series-interconnected and powered by a controller having a timer or a photosensitive sensor to determine the operating period for the system. Such outdoor lighting systems are employed to provide illumination along a pathway or a driveway, or on a deck or deck railing. Certain of these lighting fixtures, having a more focused light output, may be directed to accent a landscaping feature.

Each outdoor lighting fixture includes a light housing, a mount or support for the light housing, a light bulb within the housing, and exteriorly extending electrical conductors providing power to the light bulb. The light housing and the mount may be made from metal or plastic. The illuminating bulb in the housing may vary from a 12 volt plug-in bulb, to a 120 volt screw-in bulb. The light housing may be of a multi-tiered “pagoda” design, a globe configuration, or a spotlight including a reflector. The light housing usually includes a removable cap, cover, or element on its upper end, to facilitate bulb replacement.

These outdoor lighting fixtures have evolved and been improved over the years to provide reliable and relatively inexpensive outdoor lighting. However, it is an object of the present invention further to enhance the utility and enjoyment of existing lighting fixtures by providing a decorative light fixture extension system. It is a further object of the present invention to provide an illuminated visual image through the existing lighting fixture, communicating a theme or message of the user's choice, without detracting from the utility of the existing lighting fixture. It is yet another object to provide a system whereby the decorative light housing may quickly and easily be changed, to suit the needs or desires of the user. And, it is also an object herein to teach a socket extension, adapted to raise the height of the illuminating bulb into the decorative light housing without permanently modifying the bulb socket in the existing light fixture.

These and other objects of the present invention will be described in the drawings and in the detailed description of the preferred embodiment set forth below.

### SUMMARY OF THE INVENTION

The invention comprises a decorative light fixture extension system including a decorative light housing and a socket extension. The decorative light housing is provided with a transparent or translucent portion in its sidewall. The transparent or translucent portion has a configuration, design and color which correspond, for example, to a particular season of the year, a holiday, a political theme, or a sport team allegiance. The bottom side of the light housing is open, and includes attachment means around the periphery of the opening. The attachment means is adapted to interconnect the bottom side of the light housing to the upper end of an existing outdoor light fixture.

The socket extension comprises an elongated tubular housing, provided with a bulb inserted in a bulb socket at its upper end, and a bulb plug provided at its lower end. Electrically conductive lines interconnect the terminals of the bulb socket with the bulb plug.

The top cap or cover of an existing outdoor light fixture is removed. The bulb is removed from the light socket within the fixture and is inserted in the upper end of the socket extension. The socket extension is plugged into the existing bulb socket. The decorative light housing is lowered over the bulb and detachably secured to the upper end of the existing light fixture housing.

The decorative light housing is provided with a transparent or translucent portion which is adapted through its configuration and color, to present visual image relating, for example, to a particular season of the year, a holiday, a political theme, or a team allegiance. The means of attachment between the decorative light housing and the existing light fixture housing is such that different decorative housings may readily be substituted and utilized.

### BRIEF DESCRIPTION OF THE DRAWINGS

FIG. 1 is a perspective view of a prior art outdoor lighting fixture, of the “pagoda” style;

FIG. 2 is an exploded perspective view of the prior art lighting fixture, with the top cover removed allowing access to the illumination bulb;

FIG. 3 is a perspective view of a socket extension, the electrical conductors being shown in broken line;

FIG. 4 is an exploded perspective view of the socket extension and a bulb, in readiness for installation into the socket of the light fixture;

FIG. 5 is an exploded perspective view of a decorative light housing being installed over an existing outdoor light fixture fitted with the socket extension;

FIG. 6 is a bottom plan view of a decorative light housing including a pair of inwardly directed bosses used for attachment to the upper end of the light fixture;

FIG. 7 is a perspective view of the assembled decorative light housing and light fixture;

FIG. 8 is a fragmentary detail view, showing the manner in which the boss extending from the decorative light housing engages the L-shaped groove in the outer periphery of the upper end of the light housing;

FIG. 9 is a bottom plan view of a decorative light housing provided with an alternative attachment means, showing the opposing slots and openings located on the inner periphery of the open lower side of the decorative light housing;

FIG. 10 is a fragmentary detail view of the decorative light housing in an inverted position, showing one part of an alternative means of attachment, including a slot and an opening;

FIG. 11 is a fragmentary detail view of the decorative light housing and the light housing, showing how the decorative light housing is lowered over the light housing, and the opening in the slot is engaged by a lug on outer periphery of the light housing;

FIG. 12 is a front elevational view of the combination of a light housing with a decorative light housing featuring an illustration of a candy cane, in which no socket extension is employed;

FIG. 13 is a front elevational view of a decorative light housing featuring the image of a heart;

FIG. 14 is a front elevational view of a decorative light housing featuring the image of an Easter bunny;

FIG. 15 is a front elevational view of a decorative light housing featuring an image of Santa Claus;

FIG. 16 is a front elevational view of a decorative light housing featuring the image of a Christmas tree;

FIG. 17 is a front elevational view of a decorative light housing featuring a snowman image; and,

FIG. 18 is a front elevational view of a decorative light housing in the configuration of a baseball and featuring a promotional sports team expression.

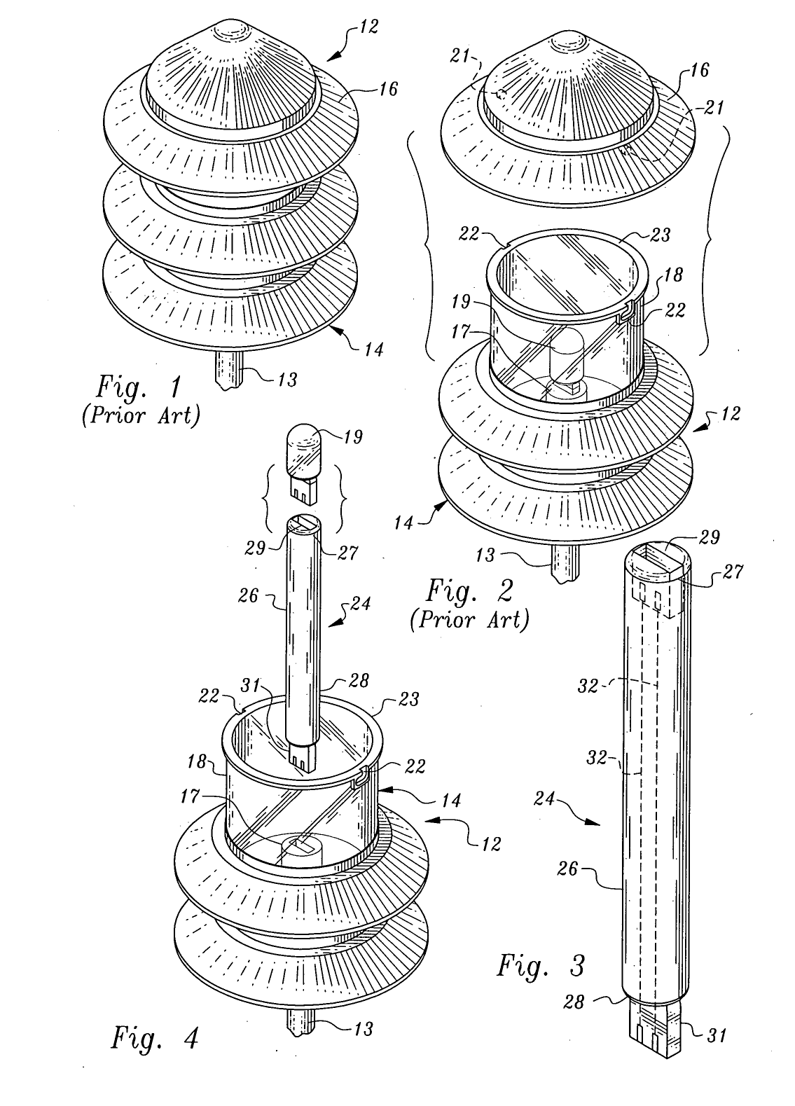

### DETAILED DESCRIPTION OF THE PREFERRED EMBODIMENT

The decorative light fixture extension system 11 of the present invention is detachably mounted over the upper, open end of an existing prior art outdoor light fixture 12. As shown in FIG. 1, light fixture 12 is of the common “pagoda” design, including a support shaft 13, a light housing 14, and a top cap or cover 16. The lower end of support shaft 13 may attach to a screw-mounted flange (not shown) or it may include a sharp tip for penetrating the ground. The upper end of shaft 13 is attached to the underside of light housing 14. Electrical conductors also pass through support shaft 13, for interconnection to a bulb socket 17, centrally positioned in the floor of light housing 14.

Light housing 14 also includes a right-circular cylindrical transparent tube 18, allowing light to pass laterally and outwardly from the fixture 12, while protecting the bulb 19 from the elements. Top cap 16 is typically made removable or detachable from housing 14, to allow initial installation and subsequent replacement of bulb 19. A variety of arrangements may be used, employing rotatable or compression fitting locking elements, such as receivers and projections. One such means of detachably securing top cap 16 to the upper edge of light housing 14 is shown in FIG. 2. This means of attachment relies upon at least one boss 21, mounted on an inner periphery of the open lower side of cap 16. Boss 21 extends radially inwardly from the inner periphery, so that when the cap is lowered over the light housing 14, the boss engages an L-shaped groove 22 in an outer periphery of the upper end 23 of the light housing 14.

For removal of the bulb 19, the process is reversed. As shown in FIG. 2, the cap 16 is rotated counter-clockwise until the boss 21 reaches the foot of the groove 22. Then, the cap 16 may be lifted upwardly, exposing the bulb 19 for removal, through the open top end 23 of light housing 14. At this juncture, a socket extension 24 may be employed to raise the elevation of the bulb 19. Socket extension 24 has an elongated body 26 with an upper end 27 and a lower end 28. Upper end 27 includes an extension bulb socket 29, and lower end 28 includes an extension bulb plug 31. Electrically conductive wires 32, interconnect extension bulb socket 29 with extension bulb plug 31. As shown in FIGS. 4 and 5, extension bulb plug 31 is installed within the existing bulb socket 17 in the light housing 14, and bulb 19 is inserted into extension bulb socket 29.

A decorative light housing 33 is provided, in this instance having a configuration and visual features which resemble a pumpkin head. Thus, the user may elect to use decorative light housing 33 prior to or during Halloween. Other designs for decorative light housings consistent with this theme may include depictions of ghosts or witches, or the words “Happy Halloween”. Whatever the theme or message to be conveyed, the decorative light housing employed has a configuration and a visual scheme consistent therewith. Patterns of transparent and translucent material may be used in the sidewall of the decorative light housing. Certain portions of the sidewall may contain apertures such as the eyes 34, the nose 36, and the mouth 37 shown in decorative light housing 33. And, colored portions in the sidewall of housing 33 may also be employed to advantage, to emphasize and clarify the visual image or message.

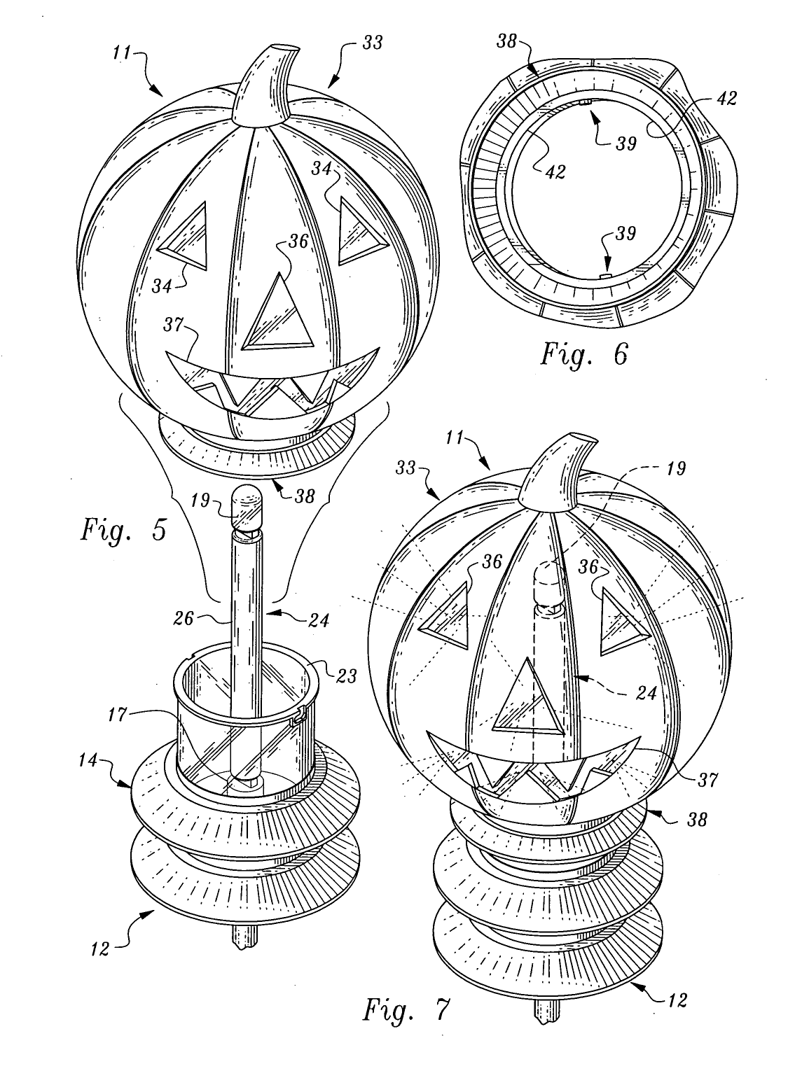

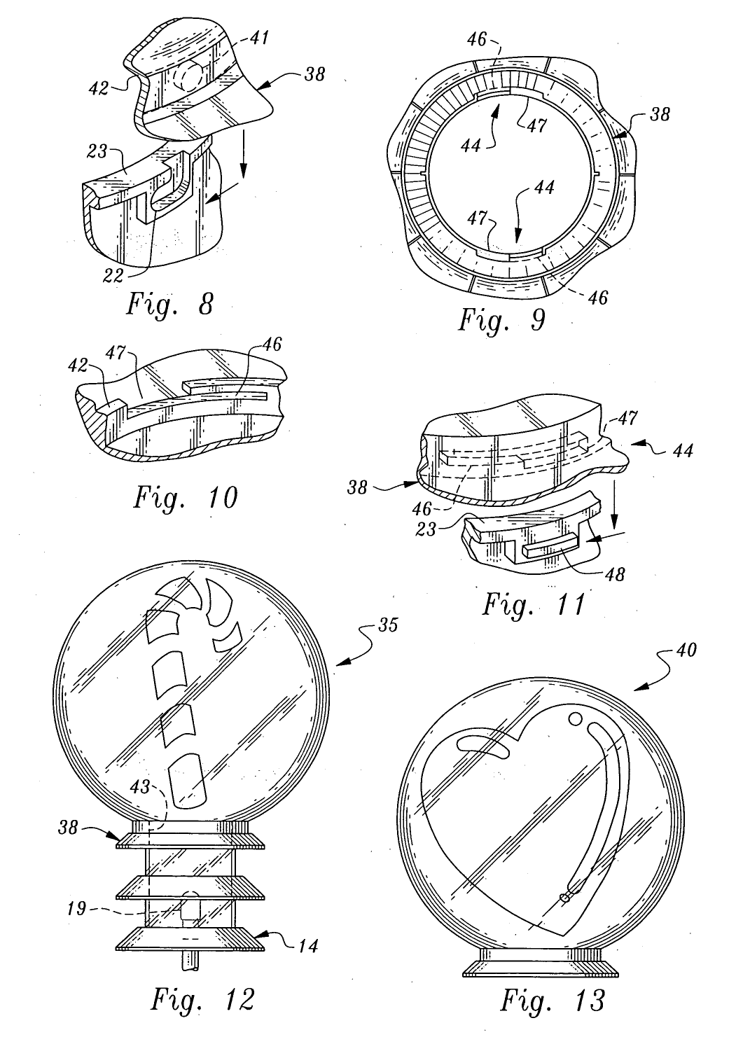

Decorative light housing 33 includes an open lower side 38 provided with attachment means 39, for detachably securing housing 33 over and to the upper end 23 of light housing 14. Attachment means 39 comprises at least one boss 41 mounted on an inner periphery 42 of open lower side 38. Boss 41 extends radially inwardly from inner periphery 42, as shown in FIG. 6. When decorative light housing 33 is lowered over light housing 14, boss 41 engages the foot portion of L-shaped groove 22 at upper end 23 of light housing 14. Then, as shown in FIG. 8, housing 33 is rotated in clock-wise fashion, securing boss 41 within the head portion of groove 22. The upper end 27 of the socket extension 24 and the bulb 19 now extend within decorative light housing 33, to provide enhanced illumination of the configuration and visual image of housing 33.

However, it may also be desirable to practice the light fixture extension system of the present invention without the use of socket extension 24. In this instance, bulb 19 would simply remain in the bulb socket 17. After decorative light housing 35 was placed over and attached to light housing 14, a light passageway 43 is defined passing through upper end 23 of light housing 14 and open lower side 38 of decorative light housing 35. (See, FIG. 12). In this configuration, bulb 19 provides illumination both to light housing 14 and to decorative light housing 35.

Yet another attachment means 44 for detachably connecting light housing 14 and decorative light housing 33 is shown in FIGS. 9, 10 and 11. Attachment means 44 comprises at least one slot 46 mounted on the inner periphery 42 of open lower side 38. Slot 46 includes an opening 47 on its lower side. Both slot 46 and opening 47 face radially inwardly from inner periphery 42, as shown in FIG. 10. A lug 48 is provided on the outer periphery of the upper end 23 of light housing 14. Making reference to FIG. 11, when decorative light housing 33 is lowered over light housing 14, lug 48 passes through opening 47 and enters slot 46. Then, when housing 33 is rotated counter-clockwise, lug 48 fully engages slot 46 securing the two light housings together.

Another equivalent attachment means for the two light housings is provided by a simple compression fit between an annular groove on one housing and an annular rib on the other housing. For example, this would be accomplished by providing an annular groove on the outer periphery of the upper end of housing 14. An annular rib would also be provided on the inner periphery of the open lower side of housing 33. Pressing housing 33 downwardly over the upper end of housing 14 would cause the rib to engage the groove, locking the two housings together.

Yet another equivalent attachment means is provided by screws and nuts. Typically, the existing light housing would have upwardly extending screws. These screws would pass through apertures in the open lower side of the decorative light housing, and nuts would be threaded over the screws to secure the two light housings together.

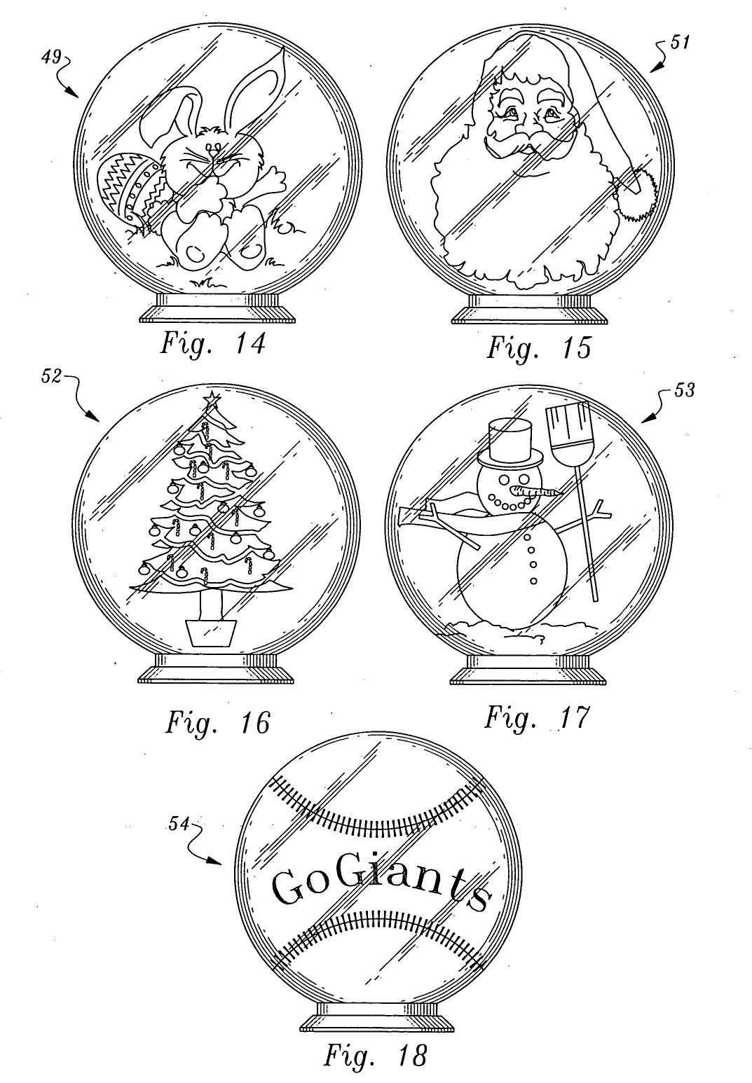

By way of example only, FIGS. 13-18 show additional configurations and images for decorative light housings, among countless others which may be adopted and used in practicing the present invention. FIG. 13 shows a decorative light housing 40 in a globe configuration, showing an illustration of a heart. FIG. 14 shows a decorative light housing 49 in a globe configuration, including the image of an Easter bunny and an Easter egg thereon. FIG. 15 shows a decorative light housing 51 provided with the facial image of Santa Claus. The visual image of a Christmas tree is shown in the decorative light housing 52, in FIG. 16. A snowman is depicted on the sidewall of the decorative light housing 53 in FIG. 17. And, the decorative light housing 54 in FIG. 18 is made in the configuration of a baseball and includes the supportive phrase “Go Giants”. As has been described, the user can pick and choose what theme or expression he or she wants to make with the previously existing outdoor lighting system, and install decorative light housings of the present invention when and as desired.

What is claimed is:

1. A decorative light fixture extension system for use with an outdoor light having a light housing with a removable access cover on its upper end, and further including a light bulb therein, the improvement comprising: a decorative light housing, said decorative light housing having an open lower side provided with attachment means for detachably securing said decorative light housing over said upper end of the light housing with said access cover removed, said decorative light housing being provided with a transparent or translucent portion, whereby a light passageway is defined through said upper end of said light housing and said open lower side of said decorative light housing, thereby providing illumination to said transparent or translucent portion of said decorative light housing.

2. A decorative light fixture extension system as in claim 1 in which said transparent or translucent portion is presented in a configuration to correspond to a particular season of the year, a holiday, a political theme, or a sport team allegiance of the user.

3. A decorative light fixture extension system as in claim 2 in which the configuration of said transparent or translucent portion corresponds to a pumpkin head.

4. A decorative light fixture extension system as in claim 2 in which the configuration of said transparent or translucent portion corresponds to a candy cane.

5. A decorative light fixture extension system as in claim 2 in which the configuration of said transparent or translucent portion corresponds to a heart.

6. A decorative light fixture extension system as in claim 2 in which the configuration of said transparent or translucent portion corresponds to a bunny rabbit and an Easter egg.

7. A decorative light fixture extension system as in claim 2 in which the configuration of said transparent or translucent portion corresponds to a Santa Claus.

8. A decorative light fixture extension system as in claim 2 in which the configuration of said transparent or translucent portion corresponds to a Christmas tree.

9. A decorative light fixture extension system as in claim 2 in which the configuration of said transparent or translucent portion corresponds to a snowman.

10. A decorative light fixture extension system for use with an outdoor light having a light housing with a light bulb socket therein, comprising:
a. socket extension having an elongated body with an upper end and a lower end, said upper end including an extension bulb socket and said lower end including an extension bulb plug, said extension bulb plug being installed within the light bulb socket in the light housing;
b. a light bulb, said light bulb being installed within said extension bulb socket;
c. a decorative light housing, said decorative light housing having an open lower side provided with attachment means for detachably securing said decorative light housing over an upper end of the light housing said upper end of said socket extension and said light bulb extending within said decorative light housing, said decorative light housing being provided with a transparent or translucent portion.

11. A decorative light fixture extension system as in claim 10 in which said transparent or translucent portion is presented in a configuration to correspond to a particular season of the year, a holiday, a political theme, or a sport team allegiance of the user.

12. A decorative light fixture extension system as in claim 10 in which said attachment means comprises at least one projection mounted on an inner periphery of said open lower side, said projection extending radially inwardly from said inner periphery, whereby when said decorative light housing is lowered over the light housing said projection engages a receiver in an outer periphery of the upper end of the light housing.

13. A decorative light fixture extension system as in claim 10 in which said attachment means comprises at least one boss mounted on an inner periphery of said open lower side, said boss extending radially inwardly from said inner periphery, whereby when said decorative light housing is lowered over said light housing said boss engages an L-shaped groove in an outer periphery of the upper end of the light housing.

14. A decorative light fixture extension system as in claim 10 in which said attachment means comprises at least one receiver mounted on an inner periphery of said open lower side, said receiver facing radially inwardly from said inner periphery, whereby when said decorative light housing is lowered over the light housing, said receiver is engaged by a projection on an outer periphery of the upper end of the light housing.

15. A decorative light fixture extension system as in claim 10 in which said attachment means comprises at least one slot mounted on an inner periphery of said open lower side, said slot including an opening on its lower side, said slot facing radially inwardly from said inner periphery, whereby when said decorative light housing is lowered over said light housing, said opening in said slot is engaged by a lug on an outer periphery of the upper end of the light housing.

16. A decorative light fixture extension system comprising:
a. an outdoor light having a light housing with a light bulb socket;
b. socket extension having an elongated body with an upper end and a lower end, said upper end including an extension bulb socket and said lower end including an extension bulb plug, said extension bulb plug being installed within said light bulb socket in said light housing;
c. a light bulb, said light bulb being installed within said extension bulb socket;
d. a decorative light housing, said decorative light housing having an open lower side provided with attachment means for detachably securing said decorative light housing over an upper end of said light housing said upper end of said socket extension and said light bulb extending within said decorative light housing, said decorative light housing being provided with a transparent or translucent portion.

17. A decorative light fixture extension system as in claim 16 in which said transparent or translucent portion is presented in a configuration to correspond to a particular season of the year, a holiday, a political theme, or a sport team allegiance of the user.

18. A decorative light fixture extension system as in claim 16 in which said attachment means comprises at least one projection mounted on an inner periphery of said open lower side, said projection extending radially inwardly from said inner periphery, whereby when said decorative light housing is lowered over said light housing said projection engages a receiver in an outer periphery of the upper end of said light housing.

19. A decorative light fixture extension system as in claim 16 in which said attachment means comprises at least one boss mounted on an inner periphery of said open lower side, said boss extending radially inwardly from said inner periphery, whereby when said decorative light housing is lowered over said light housing said boss engages an L-shaped groove in an outer periphery of the upper end of the light housing.

20. A decorative light fixture extension system as in claim 16 in which said attachment means comprises at least one receiver mounted on an inner periphery of said open lower side, said receiver facing radially inwardly from said inner periphery, whereby when said decorative light housing is lowered over said light housing, said receiver is engaged by a projection on an outer periphery of the upper end of the light housing.
